(19) United States
(12) Patent Application Publication
(10) Pub. No.: US 2007/0070552 A1
(43) Pub. Date: Mar. 29, 2007

(54) Micro-actuator and head gimbal assembly for a disk drive device

(75) Inventors: MingGao Yao, DongGuan (CN); Masashi Shiraishi, Hong Kong (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., Hong Kong (CN)

(21) Appl. No.: 11/235,549

(22) Filed: Sep. 27, 2005

(51) Int. Cl. G11B 21/24

(52) U.S. Cl. 360/294.4

(57) ABSTRACT

A micro-actuator for a head gimbal assembly includes a metal frame including a bottom support adapted to be connected to a suspension of the head gimbal assembly, a top support adapted to support a slider of the head gimbal assembly, and a pair of side arms that interconnect the bottom support and the top support. The side arms extend vertically from respective sides of the bottom support and the top support. A PZT element is mounted to each of the side arms. Each PZT element includes multiple PZT portions. Each PZT element is excitable to cause selective movement of the side arms.

### FIELD OF THE INVENTION

The present invention relates to information recording disk drive units and, more particularly, to a micro-actuator for a head gimbal assembly (HGA) of the disk drive device. More specifically, the present invention is directed to a micro-actuator that is structured to provide accurate positional adjustment of the read/write head.

### BACKGROUND OF THE INVENTION

One known type of information storage device is a disk drive device that uses magnetic media to store data and a movable read/write head that is positioned over the media to selectively read from or write to the disk.

Consumers are constantly desiring greater storage capacity for such disk drive devices, as well as faster and more accurate reading and writing operations. Thus, disk drive manufacturers have continued to develop higher capacity disk drives by, for example, increasing the density of the information tracks on the disks by using a narrower track width and/or a narrower track pitch. However, each increase in track density requires that the disk drive device have a corresponding increase in the positional control of the read/write head in order to enable quick and accurate reading and writing operations using the higher density disks. As track density increases, it becomes more and more difficult using known technology to quickly and accurately position the read/write head over the desired information tracks on the storage media. Thus, disk drive manufacturers are constantly seeking ways to improve the positional control of the read/write head in order to take advantage of the continual increases in track density.

One approach that has been effectively used by disk drive manufacturers to improve the positional control of read/write heads for higher density disks is to employ a secondary actuator, known as a micro-actuator, that works in conjunction with a primary actuator to enable quick and accurate positional control for the read/write head. Disk drives that incorporate a micro-actuator are known as dual-stage actuator systems.

Various dual-stage actuator systems have been developed in the past for the purpose of increasing the access speed and fine tuning the position of the read/write head over the desired tracks on high density storage media. Such dual-stage actuator systems typically include a primary voice-coil motor (VCM) actuator and a secondary micro-actuator, such as a PZT element micro-actuator. The VCM actuator is controlled by a servo control system that rotates the actuator arm that supports the read/write head to position the read/write head over the desired information track on the storage media. The PZT element micro-actuator is used in conjunction with the VCM actuator for the purpose of increasing the positioning access speed and fine tuning the exact position of the read/write head over the desired track. Thus, the VCM actuator makes larger adjustments to the position of the read/write head, while the PZT element micro-actuator makes smaller adjustments that fine tune the position of the read/write head relative to the storage media. In conjunction, the VCM actuator and the PZT element micro-actuator enable information to be efficiently and accurately written to and read from high density storage media.

One known type of micro-actuator incorporates PZT elements for causing fine positional adjustments of the read/write head. Such PZT micro-actuators include associated electronics that are operable to excite the PZT elements on the micro-actuator to selectively cause expansion or contraction thereof. The PZT micro-actuator is configured such that expansion or contraction of the PZT elements causes movement of the micro-actuator which, in turn, causes movement of the read/write head. This movement is used to make faster and finer adjustments to the position of the read/write head, as compared to a disk drive unit that uses only a VCM actuator. Exemplary PZT micro-actuators are disclosed in, for example, JP 2002-133803, entitled “Micro-actuator and HGA” and JP 2002-074871, entitled “Head Gimbal Assembly Equipped with Actuator for Fine Position, Disk Drive Equipped with Head Gimbals Assembly, and Manufacture Method for Head Gimbal Assembly.”

FIGS. 1 and 2 illustrate a conventional disk drive unit and show a magnetic disk 101 mounted on a spindle motor 102 for spinning the disk 101. A voice coil motor arm 104 carries a head gimbal assembly (HGA) 100 that includes a micro-actuator 105 with a slider 103 incorporating a read/write head. A voice-coil motor (VCM) 115 is provided for controlling the motion of the motor arm 104 and, in turn, controlling the slider 103 to move from track to track across the surface of the disk 101, thereby enabling the read/write head to read data from or write data to the disk 101. In operation, a lift force is generated by the aerodynamic interaction between the slider 103, incorporating the read/write head, and the spinning magnetic disk 101. The lift force is opposed by equal and opposite spring forces applied by a suspension of the HGA 100 such that a predetermined flying height above the surface of the spinning disk 101 is maintained over a full radial stroke of the motor arm 104.

FIG. 3 illustrates the head gimbal assembly (HGA) 100 of the conventional disk drive device of FIGS. 1-2 incorporating a dual-stage actuator. However, because of the inherent tolerances of the VCM and the head suspension assembly, the slider 103 cannot achieve quick and fine position control which adversely impacts the ability of the read/write head to accurately read data from and write data to the disk. As a result, a PZT micro-actuator 105, as described above, is provided in order to improve the positional control of the slider and the read/write head. More particularly, the PZT micro-actuator 105 corrects the displacement of the slider 103 on a much smaller scale, as compared to the VCM, in order to compensate for the resonance tolerance of the VCM and/or head suspension assembly. The micro-actuator 105 enables, for example, the use of a smaller recording track pitch, and can increase the “tracks-per-inch” (TPI) value by 50% for the disk drive unit, as well as provide an advantageous reduction in the head seeking and settling time. Thus, the PZT micro-actuator 105 enables the disk drive device to have a significant increase in the surface recording density of the information storage disks used therein.

Referring more particularly to FIGS. 3 and 4, a conventional PZT micro-actuator 105 includes a ceramic U-shaped frame which has two ceramic beams or side arms 107 each having a PZT element thereon. The ceramic beams 107 hold the slider 103 therebetween and displace the slider 103 by movement of the ceramic beams 107. The PZT micro-actuator 105 is physically coupled to a flexure 114 of suspension 113. Three electrical connection balls 109 (gold ball bonding or solder ball bonding, GBB or SBB) are provided to couple the micro-actuator 105 to the suspension traces 110 located at the side of each of the ceramic beams 107. In addition, there are four metal balls 108 (GBB or SBB) for coupling the slider 103 to the traces 110.

FIG. 5 generally shows an exemplary process for assembling the slider 103 with the micro-actuator 105. As illustrated, the slider 103 is partially bonded with the two ceramic beams 107 at two predetermined positions 106 (also see FIG. 3) by epoxy 112. This bonding makes the movement of the slider 103 dependent on the movement of the ceramic beams 107 of the micro-actuator 105. A PZT element 116 is attached on each of the ceramic beams 107 of the micro-actuator to enable controlled movement of the slider 103 through excitation of the PZT elements 116. More particularly, when power is supplied through the suspension traces 110, the PZT elements 116 expand or contract to cause the two ceramic beams 107 of the U-shape micro-actuator frame to deform, thereby making the slider 103 move on the track of the disk in order to fine tune the position of the read/write head. In this manner, controlled displacement of slider 103 can be achieved for fine positional tuning.

While the PZT micro-actuator described above provides an effective and reliable solution for fine tuning the position of the slider, it also includes certain drawbacks. More particularly, since the above-described design includes a U-shaped ceramic frame, the brittleness of the ceramic material effects the shock performance. Also, the brittleness of the ceramic material generates ceramic particles when a shock event or vibration occurs. Further, the additional mass of the micro-actuator may effect the static and dynamic performance of the HGA such as the resonance performance and head flying stability. In addition, the ceramic material effects manufacture and process handling.

Thus, there is a need for an improved micro-actuator for use in head gimbal assemblies and disk drive units that does not suffer from the above-mentioned drawbacks.

### SUMMARY OF THE INVENTION

One aspect of the present invention relates to a micro-actuator that includes a metal frame.

Another aspect of the present invention relates to a micro-actuator that includes multiple PZT portions.

Another aspect of the invention relates to a micro-actuator for a head gimbal assembly. The micro-actuator includes a metal frame including a bottom support adapted to be connected to a suspension of the head gimbal assembly, a top support adapted to support a slider of the head gimbal assembly, and a pair of side arms that interconnect the bottom support and the top support. The side arms extend vertically from respective sides of the bottom support and the top support. A PZT element is mounted to each of the side arms. Each PZT element includes multiple PZT portions. Each PZT element is excitable to cause selective movement of the side arms.

Another aspect of the invention relates to a micro-actuator for a head gimbal assembly. The micro-actuator includes a metal frame including a pair of side arms, a plate, and connection arms that interconnect the plate with the side arms. A PZT element is mounted to each of the side arms. Each PZT element includes multiple PZT portions. Each PZT element is excitable to cause selective movement of the side arms.

Another aspect of the invention relates to a micro-actuator for a head gimbal assembly. The micro-actuator includes a metal frame including a pair of side arms, and a plate connected between the side arms. A PZT element is mounted to each of the side arms. Each PZT element includes multiple PZT portions. Each PZT element is excitable to cause selective movement of the side arms.

Another aspect of the invention relates to a micro-actuator for a head gimbal assembly. The micro-actuator includes a metal frame including a plate, and a first pair of side arms connected to one side of the plate and a second pair of side arms connected to an opposite side of the plate. A PZT element is mounted to each of the side arms. Each PZT element includes multiple PZT portions. Each PZT element is excitable to cause selective movement of the side arms.

Yet another aspect of the invention relates to a head gimbal assembly including a micro-actuator, a slider, and a suspension that supports the micro-actuator and the slider. The micro-actuator includes a metal frame including a bottom support adapted to be connected to a suspension of the head gimbal assembly, a top support adapted to support a slider of the head gimbal assembly, and a pair of side arms that interconnect the bottom support and the top support. The side arms extend vertically from respective sides of the bottom support and the top support. A PZT element is mounted to each of the side arms. Each PZT element includes multiple PZT portions. Each PZT element is excitable to cause selective movement of the side arms.

Still another aspect of the invention relates to a disk drive device including a head gimbal assembly, a drive arm connected to the head gimbal assembly, a disk, and a spindle motor operable to spin the disk. The head gimbal assembly includes a micro-actuator, a slider, and a suspension that supports the micro-actuator and slider. The micro-actuator includes a metal frame including a bottom support adapted to be connected to a suspension of the head gimbal assembly, a top support adapted to support a slider of the head gimbal assembly, and a pair of side arms that interconnect the bottom support and the top support. The side arms extend vertically from respective sides of the bottom support and the top support. A PZT element is mounted to each of the side arms. Each PZT element includes multiple PZT portions. Each PZT element is excitable to cause selective movement of the side arms.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1 is a perspective view of a conventional disk drive unit;

FIG. 2 is a partial perspective view of the conventional disk drive unit shown in FIG. 1;

FIG. 3 is a perspective view of a conventional head gimbal assembly (HGA);

FIG. 4 is an enlarged, partial perspective view of the HGA shown in FIG. 3;

FIG. 5 illustrates a general process of inserting a slider into the micro-actuator of the HGA shown in FIGS. 3 and 4;

FIG. 6 is a perspective view of a head gimbal assembly (HGA) including a PZT micro-actuator according to an embodiment of the present invention;

FIG. 7 is a partial perspective of the HGA shown in FIG. 6;

FIG. 8 is a side view of the HGA shown in FIG. 7;

FIG. 9 is a cross-sectional view of an embodiment of a PZT element of the PZT micro-actuator shown in FIG. 6;

FIG. 10 is a cross-sectional view of another embodiment of a PZT element of the PZT micro-actuator shown in FIG. 6;

FIG. 11 is an exploded view of the PZT micro-actuator shown in FIG. 6;

FIG. 12 is an exploded view of the HGA shown in FIG. 6;

FIG. 13 is a perspective view of the assembled HGA shown in FIG. 6;

FIG. 14 is an exploded view of a slider and a PZT micro-actuator according to another embodiment of the present invention;

FIG. 15 is an assembled perspective view of the slider and PZT micro-actuator shown in FIG. 14;

FIG. 16 is an exploded view of a slider and a PZT micro-actuator according to another embodiment of the present invention;

FIG. 17 is an assembled perspective view of the slider and PZT micro-actuator shown in FIG. 16;

FIG. 18 is an exploded view of a PZT micro-actuator according to another embodiment of the present invention;

FIG. 19 is an exploded view of a PZT micro-actuator according to yet another embodiment of the present invention;

FIG. 20 is an exploded view of a PZT micro-actuator according to still another embodiment of the present invention; and

FIG. 21 is an assembled perspective view of the PZT micro-actuator shown in FIG. 20.

### DETAILED DESCRIPTION OF ILLUSTRATED EMBODIMENTS

Various preferred embodiments of the instant invention will now be described with reference to the figures, wherein like reference numerals designate similar parts throughout the various views. As indicated above, the instant invention is designed to provide accurate positional adjustment of the read/write head using the micro-actuator. An aspect of the instant invention is to provide a PZT micro-actuator configured to improve shock performance, head static performance, resonance performance, and/or manufacturing in the HGA. By improving performance and/or manufacturing of the HGA, the performance and/or manufacturing characteristics of the device are improved.

Several example embodiments of a micro-actuator for a HGA will now be described. It is noted that the micro-actuator may be implemented in any suitable disk drive device having a micro-actuator in which it is desired to improve performance and/or manufacturing, regardless of the specific structure of the HGA as illustrated in the figures. That is, the invention may be used in any suitable device having a micro-actuator in any industry.

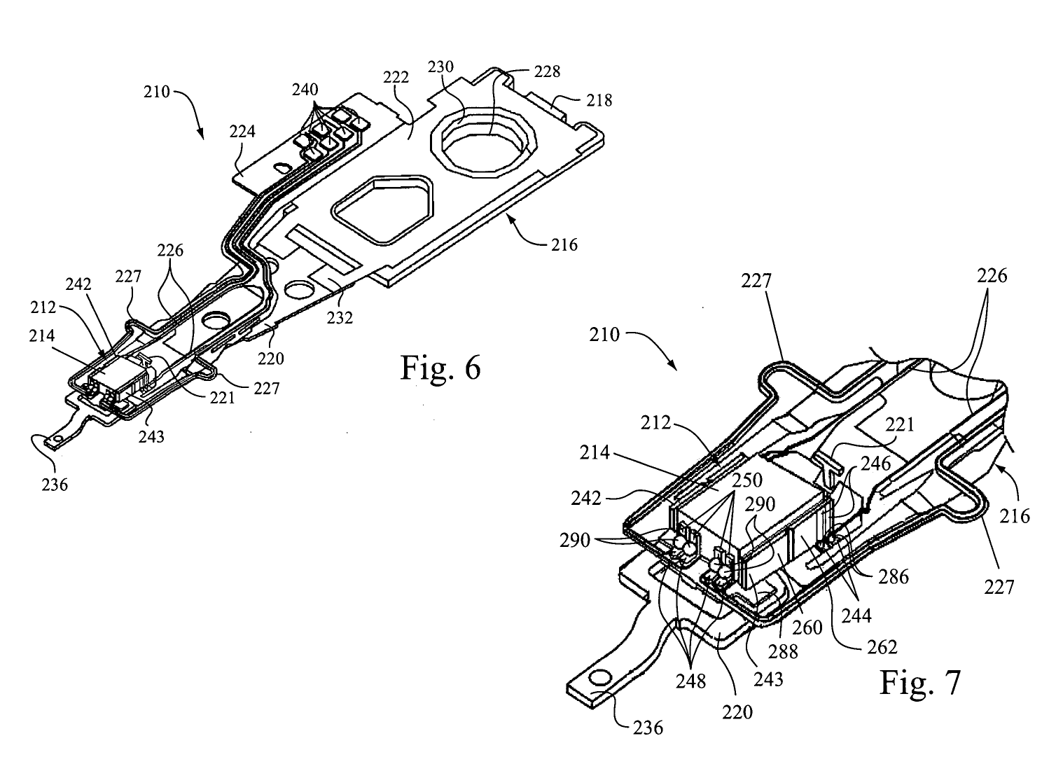

FIGS. 6-13 illustrate a head gimbal assembly (HGA) 210 incorporating a PZT micro-actuator 212 according to a first exemplary embodiment of the present invention. The HGA 210 includes a PZT micro-actuator 212, a slider 214, and a suspension 216 to load or suspend the PZT micro-actuator 212 and the slider 214.

As illustrated, the suspension 216 includes a base plate 218, a load beam 220, a hinge 222, a flexure 224, and inner and outer suspension traces 226, 227 in the flexure 224. The base plate 218 includes a mounting hole 228 for use in connecting the suspension 216 to a drive arm of a voice coil motor (VCM) of a disk drive device. The shape of the base plate 218 may vary depending on the configuration or model of the disk drive device. Also, the base plate 218 is constructed of a relatively hard or rigid material, e.g., metal, to stably support the suspension 216 on the drive arm of the VCM.

The hinge 222 is mounted onto the base plate 218 and load beam 220, e.g., by welding. As illustrated, the hinge 222 includes a hole 230 that align with the hole 228 provided in the base plate 218. Also, the hinge 222 includes a holder bar 232 for supporting the load beam 220.

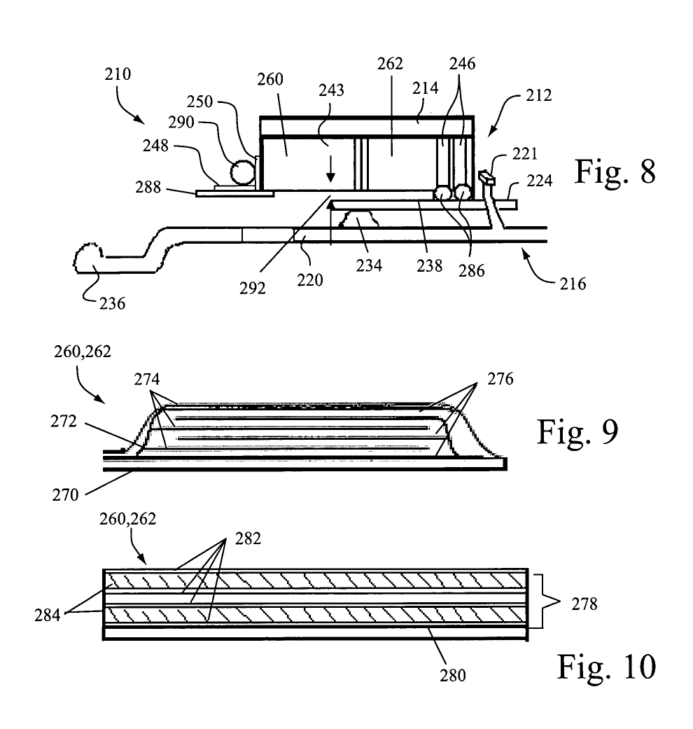

The load beam 220 is mounted onto the holder bar 232 of the hinge 222, e.g., by welding. The load beam 220 has a dimple 234 formed thereon for engaging the flexure 224 (see FIG. 8). The load beam 220 functions as a rigid body. An optional lift tab 236 may be provided on the load beam 220 to lift the HGA 210 from the disk when the disk is not rotated.

The flexure 224 is mounted to the hinge 222 and the load beam 220, e.g., by lamination or welding. The flexure 224 provides a suspension tongue 238 to couple the PZT micro-actuator 212 to the suspension 216 (see FIGS. 8 and 12). The suspension tongue 238 engages the dimple 234 on the load beam 220. Also, a limiter 221 extends from the load beam 220 to limit movement of the suspension tongue 238 during operation of the disk drive device or in the event of a mechanical shock or vibration to the suspension or the disk drive device. Further, the suspension traces 226, 227 are provided on the flexure 224 to electrically connect a plurality of connection pads 240 (which connect to an external control system) with the slider 214 and the PZT elements 242, 243 on the PZT micro-actuator 212. The suspension traces 226, 227 may be a flexible printed circuit (FPC) and may include any suitable number of lines.

As best shown in FIGS. 7, 8 and 12, bonding pads 244 are directly connected to the inner suspension traces 226 to electrically connect the inner suspension traces 226 with bonding pads 246 provided on the PZT elements 242, 243. Also, bonding pads 248 are directly connected to the outer suspension traces 227 to electrically connect the outer suspension traces 227 with bonding pads 250 provided on the slider 214.

A voice-coil motor (VCM) is provided in the disk drive device for controllably driving the drive arm and, in turn, the HGA 210 in order to enable the HGA 210 to position the slider 214, and associated read/write head, over any desired information track on a disk in the disk drive device. The PZT micro-actuator 212 is provided to enable faster and finer positional control for the device, as well as to reduce the head seeking and settling time during operation. Thus, when the HGA 210 is incorporated into a disk drive device, a dual-stage actuator system is provided in which the VCM actuator provides large positional adjustments and the PZT micro-actuator 212 provides fine positional adjustments for the read/write head.

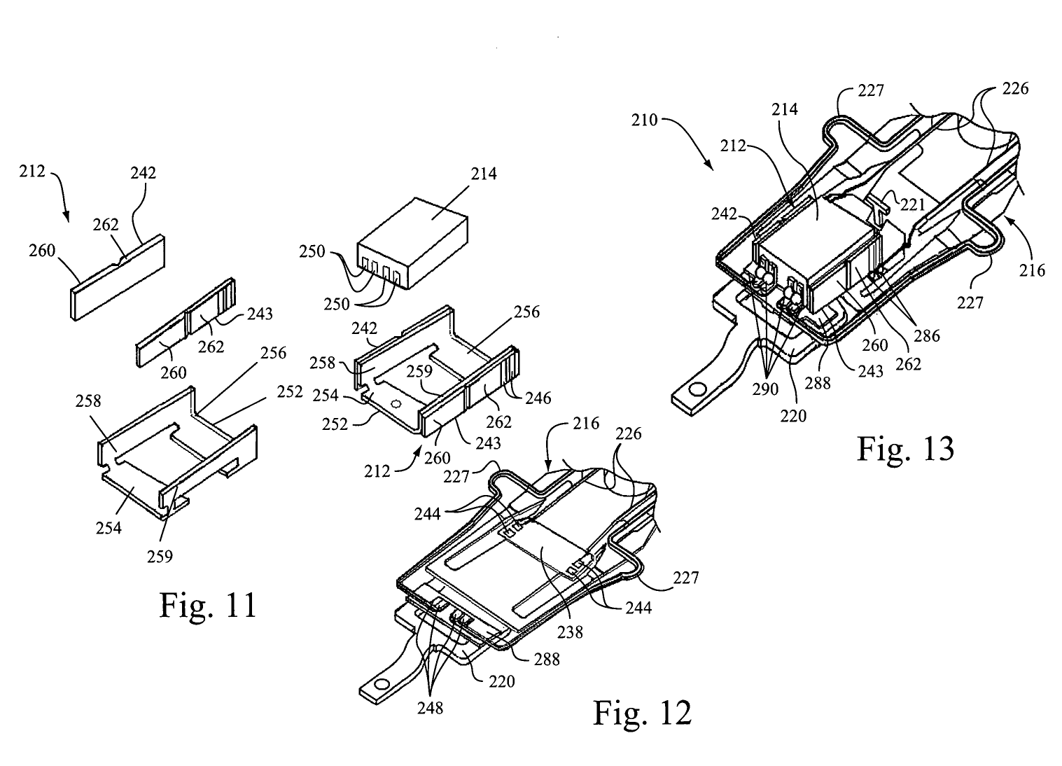

FIGS. 11 and 12 illustrate the PZT micro-actuator 212 removed from the slider 214 and the suspension 216. As illustrated, the PZT micro-actuator 212 includes a micro-actuator frame 252 and PZT elements 242, 243 mounted to the micro-actuator frame 252. The micro-actuator frame 252 includes a top support 254, a bottom support 256, and side arms 258, 259 that interconnect the top support 254 and bottom support 256. A PZT element 242, 243 is mounted to respective side arms 258, 259 of the micro-actuator frame 252 to provide the PZT micro-actuator 212. The micro-actuator frame 252 preferably constructed of metal. However, the frame 252 may be constructed of other suitable materials, e.g., hard polymer.

As best shown in FIG. 11, the side arms 258, 259 are formed from opposing sides of the top and bottom supports 254, 256. As illustrated, notches exist between the top and bottom supports 254, 256 and respective side arms 258, 259. This arrangement will allow the side arms 258, 259 more freedom of movement.

As best shown in FIGS. 7, 8, 11, 12, each PZT element 242, 243 includes two PZT portions 260, 262. Also, bonding pads 246, e.g., two pads, are provided on the PZT elements 242, 243 for electrically connecting the PZT elements 242, 243 to the inner suspension traces 226. The PZT portions 260, 262 may be a ceramic PZT or a thin-film PZT and may include multiple layers or a single layer.

In one embodiment, as shown in FIG. 9, each PZT portion 260, 262 may have a bulk-type ceramic PZT structure. In one of the other embodiments, as illustrated in FIG. 9, each PZT portion 260, 262 may include a substrate base 270 and a PZT structure 272. The substrate base 270 may be ceramic and the PZT structure 272 may be a multi-layer PZT. The multi-layer PZT includes multiple electrodes 274 and 276 and the PZT crystal are sandwiched between these electrodes. When a voltage is applied to the electrodes 274, 276, the PZT crystal will demonstrate PZT properties and generate movement. In another embodiment, the PZT structure may be a single layer PZT. In yet another embodiment, each PZT portion may not have a substrate base and only have a PZT structure.

In another embodiment, as shown in FIG. 10, each PZT portion 260, 262 may have thin-film PZT pieces. As illustrated, each PZT portion 260, 262 may include a two-layer PZT structure 278 and a substrate base 280. Each layer of the PZT structure 278 may have two electrodes 282 that sandwich a thin-film PZT layer 284. The two layers of the PZT structure 278 may be coupled by epoxy. In an embodiment, the substrate base 280 may be silicon or MgO. When a voltage is applied to the electrodes 282, the PZT layers 284 will demonstrate PZT properties and generate movement.

As best shown in FIGS. 7, 8, and 13, the bottom support 256 is structured to connect the micro-actuator frame 252 to the suspension 216. Specifically, the bottom support 256 is partially mounted to the suspension tongue 238 of the flexure 224, e.g., by epoxy, resin, or welding by laser. Also, the PZT bonding pads 246, e.g., two bonding pads, provided on respective PZT elements 242, 243 are electrically connected to respective bonding pads 244 on the inner suspension traces 226 using electrical connection balls (GBB or SBB) 286. This allows power to be applied via the inner suspension traces 226 to the PZT elements 242, 243.

The top support 254 is structured to connect the micro-actuator frame 252 to the slider 214. Specifically, the slider 214 has bonding pads 250, e.g., four bonding pads, on an end thereof corresponding to the slider bonding pads 248 provided on a float plate 288. The top support 254 supports the slider 214 thereon and the slider bonding pads 248 are electrically bonded with respective pads 250 provided on the slider 214 using, for example, electric connection balls (GBB or SBB) 290. This connects the top support 254 to the slider 214 and electrically connects the slider 214 and its read/write elements to the outer suspension traces 227 on the suspension 216. Also, a parallel gap 292 is provided between the suspension tongue 238 and the slider 214 to allow the slider 214 to move freely in use, as shown in FIG. 8.

In an embodiment, the HGA 210 may be manufactured by first attaching the PZT elements 242, 243 to respective arms of the micro-actuator frame 252 (see FIG. 11), then bonding the slider 214 to the micro-actuator frame 252 (see FIG. 12), and finally attaching the micro-actuator frame 252 with the PZT elements 242, 243 and slider 214 to the suspension 216 (see FIG. 13).

The above-described PZT micro-actuator design has several advantages. For example, because the PZT micro-actuator 212 includes a metal frame 252 with PZT elements 242, 243, the PZT micro-actuator 212 provides stronger shock performance. This structure also has less mass which will improve head static performance such as resonance/flying stability. Further, the metal frame is relatively easy to integrate to the CIS or TSA suspension, e.g., using laser welding, which provides more accurate control of manufacturing. In addition, this structure facilitates manufacture and process handling. Also, the PZT micro-actuator 212 can achieve a relatively large stroke with high resonance performance.

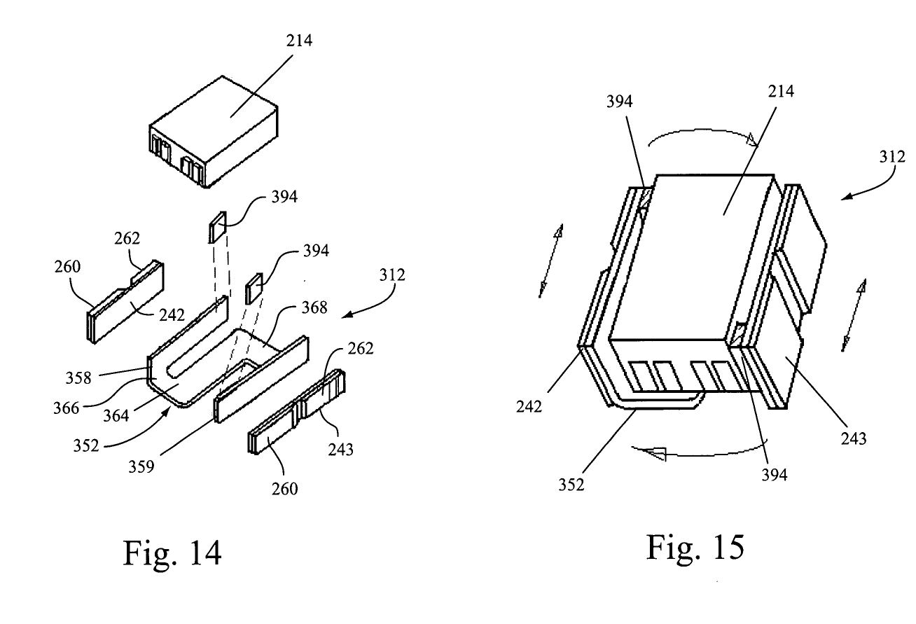

FIGS. 14 and 15 illustrate a PZT micro-actuator 312 according to another exemplary embodiment of the present invention. In this embodiment, the micro-actuator frame 352 includes side arms 358, 359, plate 364, and connection arms 366, 368 that interconnect the plate 364 with the side arms 358, 359. As illustrated, the side arms 358, 359 are cross-coupled to the plate 364 such that the connection arm 366 is coupled to a front portion of the side arm 358 and the connection arm 368 is coupled to a rear portion of the side arm 359. PZT elements 242, 243 each including PZT portions 260, 262 are mounted to respective side arms 358, 359. A slider 214 is partially mounted to the frame 352 by mounting a trailing side edge of the slider 214 to one side arm 358 and mounting a leading side edge of the slider 214 to the other side arm 359. The slider 214 may be mounted to the frame 352 by epoxy dots 394, for example. As shown in FIG. 15, when a positive voltage is applied to the PZT elements 242, 243, the PZT elements 242, 243 will shrink which will bend the side arms 358, 359. This movement will pull the slider 214 in opposed sides and generate a torque which will cause the slider 214 to rotate. The components of the PZT micro-actuator 312 that are substantially similar to the PZT micro-actuator 212 are indicated with similar reference numerals.

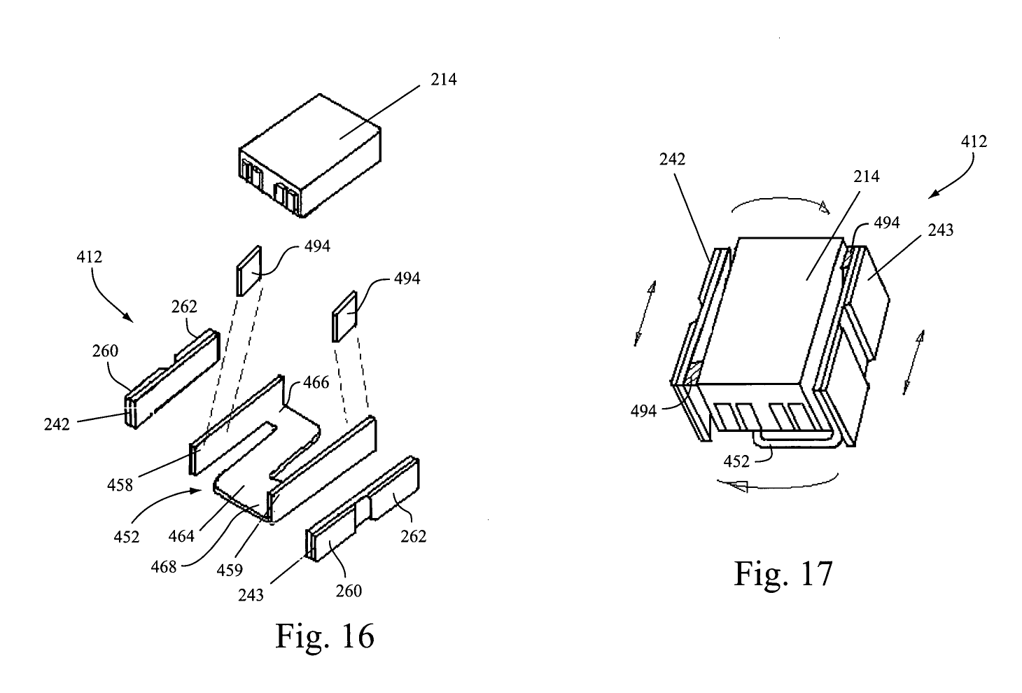

FIGS. 16 and 17 illustrate a PZT micro-actuator 412 according to another exemplary embodiment of the present invention. The PZT micro-actuator 412 is substantially similar to the PZT micro-actuator 312. In contrast, the micro-actuator frame 452 includes side arms 458, 459 that are cross-coupled to the plate 464 such that the connection arm 466 is coupled to a rear portion of the side arm 458 and the connection arm 468 is coupled to a front portion of the side arm 459. A slider 214 is partially mounted to the frame 452 by mounting a leading side edge of the slider 214 to one side arm 458 and mounting a trailing side edge of the slider 214 to the other side arm 459. The slider 214 may be mounted to the frame 452 by epoxy dots 494, for example. As shown in FIG. 17, operation of the PZT micro-actuator 412 is substantially similar to the PZT micro-actuator 312 described above.

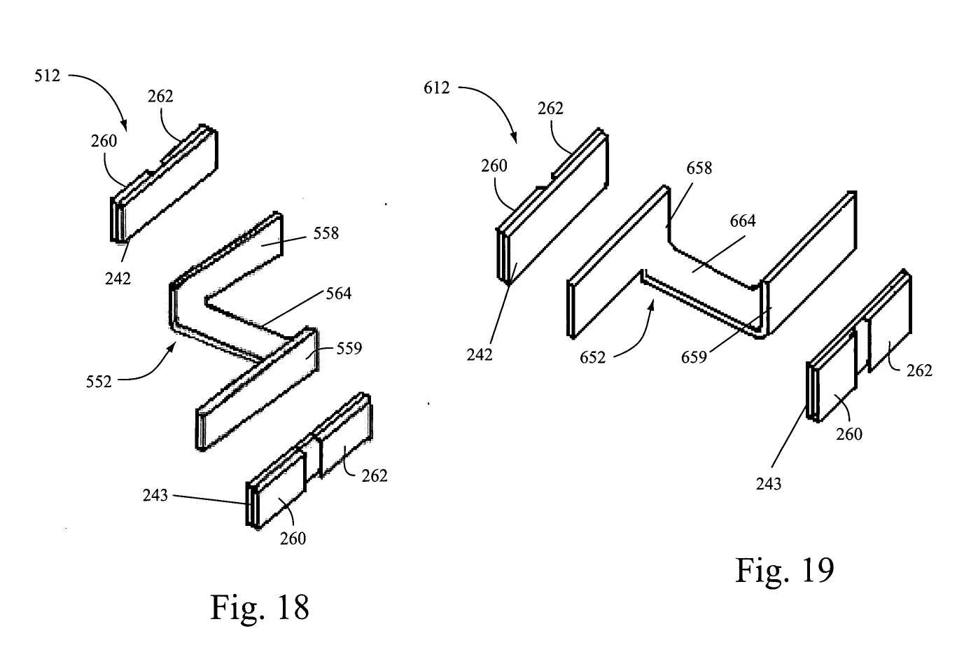

FIG. 18 illustrates a PZT micro-actuator 512 according to another exemplary embodiment of the present invention. In this embodiment, the micro-actuator frame 552 is N-shaped and includes side arms 558, 559 and a plate 564 connected between the side arms 558, 559. As illustrated, the side arms 558, 559 are cross-coupled to the plate 564 such that one end of the plate 564 is coupled to a front portion of the side arm 558 and the opposite end of the plate 564 is coupled to a rear portion of the side arm 559. PZT elements 242, 243 each including PZT portions 260, 262 are mounted to respective side arms 558, 559. A slider (not shown) may be mounted to free ends of respective side arms 558, 559.

FIG. 19 illustrates a PZT micro-actuator 612 according to yet another exemplary embodiment of the present invention. The PZT micro-actuator 612 is substantially similar to the PZT micro-actuator 512. In contrast, the micro-actuator frame 652 includes side arms 658, 659 that are cross-coupled to the plate 664 such that one end of the plate 664 is coupled to a rear portion of the side arm 658 and the opposite end of the plate 664 is coupled to a front portion of the side arm 559.

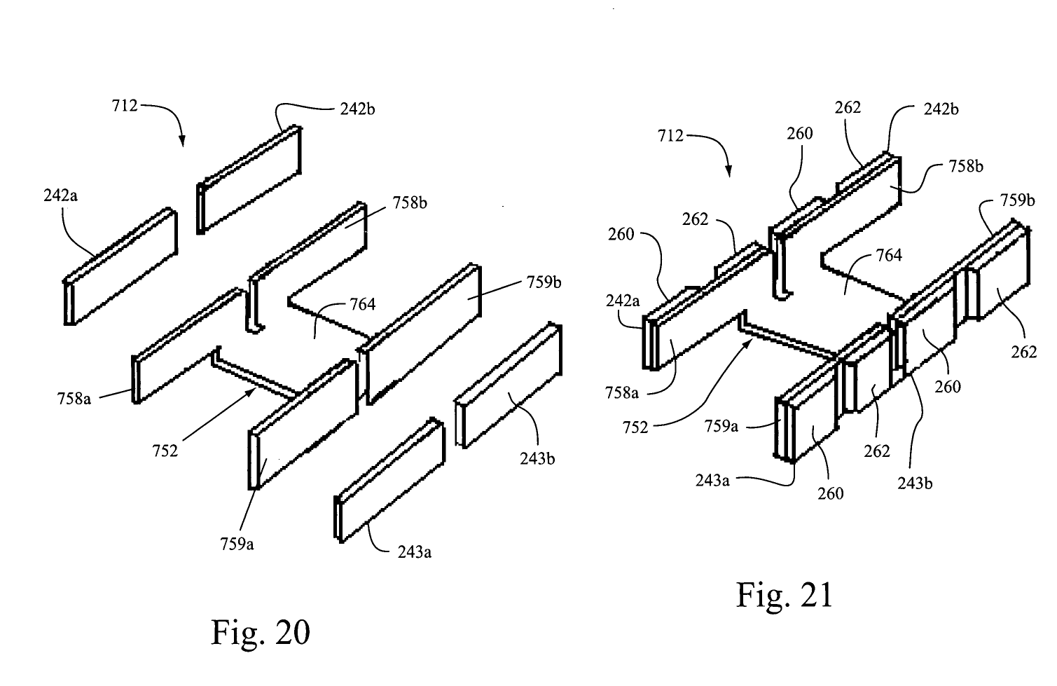

FIGS. 20 and 21 illustrate a PZT micro-actuator 712 according to still another exemplary embodiment of the present invention. In this embodiment, the micro-actuator frame 752 is H-shaped. Specifically, the frame 752 includes a plate 764 and a pair of side arms connected to each side of the plate 764. Thus, one side of the plate includes side arms 758a, 758b and the opposite side of the plate includes side arms 759a, 759b. PZT elements 242a, 242b, 243a, 243b each including PZT portions 260, 262 are mounted to respective side arms 758a, 758b, 759a, 759b. As illustrated, the PZT micro-actuator 712 includes four PZT elements 242a, 242b, 243a, 243b attached to four side arms 758a, 758b, 759a, 759b. FIG. 21 is an assembled view of the PZT micro-actuator 712.

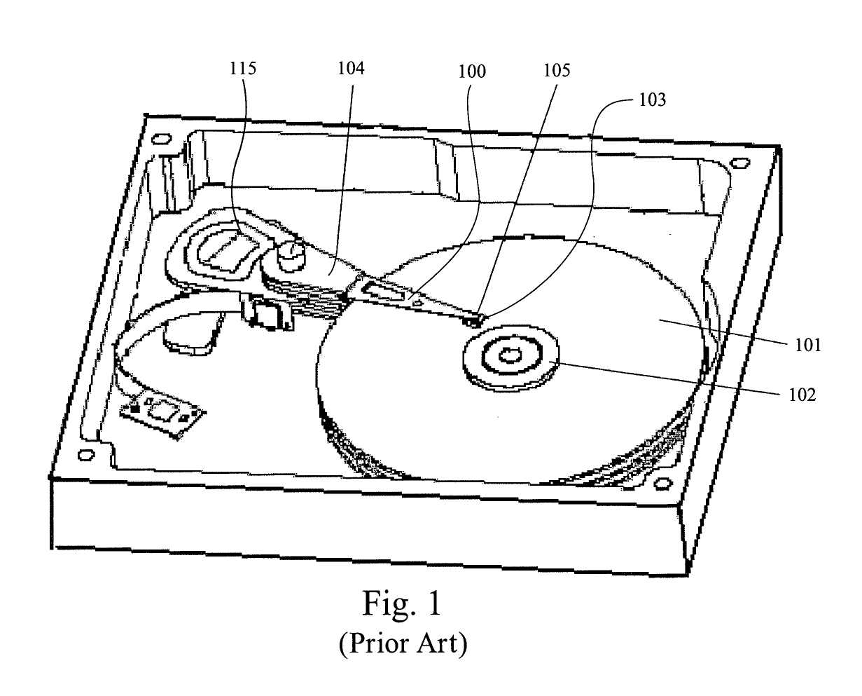

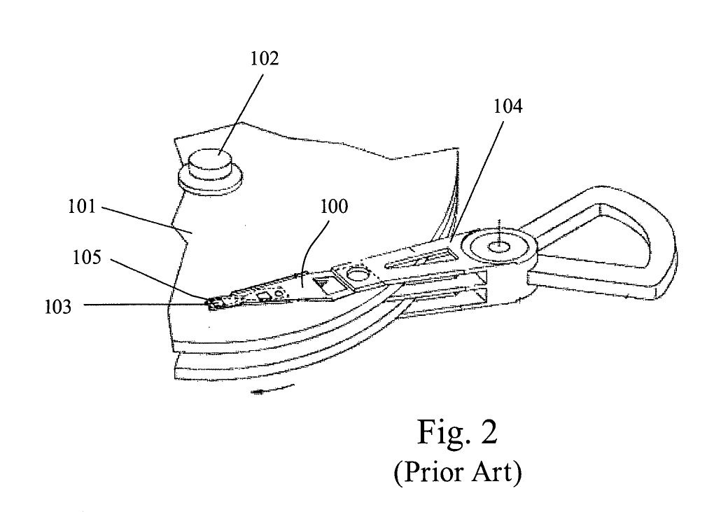

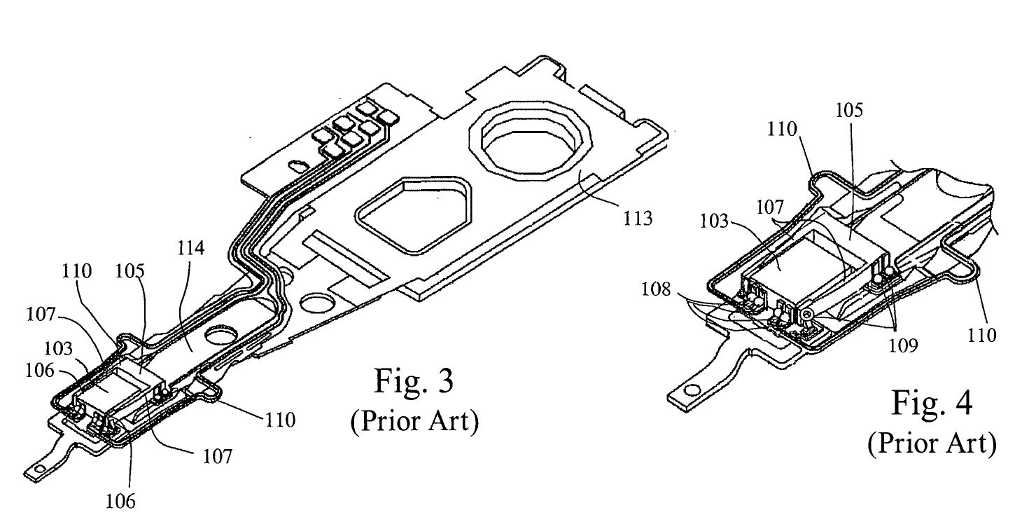

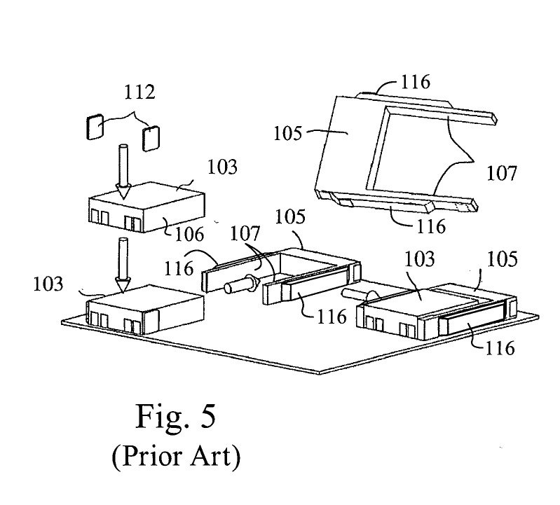

A head gimbal assembly 210 incorporating a PZT micro-actuator 212, 312, 412, 512, 612, 712 according to embodiments of the present invention may be provided to a disk drive device (HDD). The HDD may be of the type described above in connection with FIG. 1. Because the structure, operation and assembly processes of disk drive devices are well known to persons of ordinary skill in the art, further details regarding the disk drive device are not provided herein so as not to obscure the invention. The PZT micro-actuator can be implemented in any suitable disk drive device having a micro-actuator or any other device with a micro-actuator. In an embodiment, the PZT micro-actuator is used in a high RPM disk drive device.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A micro-actuator for a head gimbal assembly, comprising:
a metal frame including
a bottom support adapted to be connected to a suspension of the head gimbal assembly,
a top support adapted to support a slider of the head gimbal assembly, and
a pair of side arms that interconnect the bottom support and the top support,
the side arms extending vertically from respective sides of the bottom support and the top support; and
a PZT element mounted to each of the side arms, each PZT element including multiple PZT portions, wherein each PZT element is excitable to cause selective movement of the side arms.

2. The micro-actuator according to claim 1, wherein each PZT element includes at least two PZT portions.

3. The micro-actuator according to claim 1, wherein each PZT element is ceramic PZT or thin-film PZT.

4. The micro-actuator according to claim 1, wherein each PZT element includes single-layer PZT.

5. The micro-actuator according to claim 1, wherein each PZT element includes multi-layer PZT.

6. The micro-actuator according to claim 1, wherein each of the PZT portions includes a substrate base and a PZT structure.

7. The micro-actuator according to claim 6, wherein the PZT structure is a multi-layer PZT including multiple electrodes and PZT crystal sandwiched between the electrodes.

8. The micro-actuator according to claim 1, wherein each of the PZT portions includes a substrate base and a multi-layer PZT structure.

9. The micro-actuator according to claim 8, wherein each layer of the PZT structure includes two electrodes that sandwich a thin-film PZT layer.

10. A micro-actuator for a head gimbal assembly, comprising:
a metal frame including
a pair of side arms,
a plate, and
connection arms that interconnect the plate with the side arms; and
a PZT element mounted to each of the side arms, each PZT element including multiple PZT portions, wherein each PZT element is excitable to cause selective movement of the side arms.

11. The micro-actuator according to claim 10, wherein the side arms are cross-coupled to the plate such that one of the connection arms is coupled to a front portion of one of the side arms and the other of the connection arms is coupled to a rear portion of the other of the side arms.

12. The micro-actuator according to claim 10, wherein each PZT element includes at least two PZT portions.

13. The micro-actuator according to claim 10, wherein each PZT element is ceramic PZT or thin-film PZT.

14. The micro-actuator according to claim 10, wherein each PZT element includes single-layer PZT.

15. The micro-actuator according to claim 10, wherein each PZT element includes multi-layer PZT.

16. A micro-actuator for a head gimbal assembly, comprising:
a metal frame including
a pair of side arms, and
a plate connected between the side arms; and
a PZT element mounted to each of the side arms, each PZT element including multiple PZT portions, wherein each PZT element is excitable to cause selective movement of the side arms.

17. The micro-actuator according to claim 16, wherein the side arms are cross-coupled to the plate such that one end of the plate is coupled to a front portion of one of the side arms and the other end of the plate is coupled to a rear portion of the other of the side arms.

18. The micro-actuator according to claim 16, wherein each PZT element includes at least two PZT portions.

19. The micro-actuator according to claim 16, wherein each PZT element is ceramic PZT or thin-film PZT.

20. The micro-actuator according to claim 16, wherein each PZT element includes single-layer PZT.

21. The micro-actuator according to claim 16, wherein each PZT element includes multi-layer PZT.

22. A micro-actuator for a head gimbal assembly, comprising:
a metal frame including
a plate, and
a first pair of side arms connected to one side of the plate and a second pair of side arms connected to an opposite side of the plate; and
a PZT element mounted to each of the side arms, each PZT element including multiple PZT portions, wherein each PZT element is excitable to cause selective movement of the side arms.

23. The micro-actuator according to claim 22, wherein each PZT element includes at least two PZT portions.

24. The micro-actuator according to claim 22, wherein each PZT element is ceramic PZT or thin-film PZT.

25. The micro-actuator according to claim 22, wherein each PZT element includes single-layer PZT.

26. The micro-actuator according to claim 22, wherein each PZT element includes multi-layer PZT.

27. A head gimbal assembly comprising:
a micro-actuator;
a slider; and
a suspension that supports the micro-actuator and the slider,
wherein the micro-actuator includes:
a metal frame including
a bottom support adapted to be connected to a suspension of the head gimbal assembly,
a top support adapted to support a slider of the head gimbal assembly, and
a pair of side arms that interconnect the bottom support and the top support,
the side arms extending vertically from respective sides of the bottom support and the top support; and
a PZT element mounted to each of the side arms, each PZT element including multiple PZT portions, wherein each PZT element is excitable to cause selective movement of the side arms.

28. The head gimbal assembly according to claim 27, wherein each PZT element includes at least two PZT portions.

29. The head gimbal assembly according to claim 27, wherein each PZT element is ceramic PZT or thin-film PZT.

30. The head gimbal assembly according to claim 27, wherein each PZT element includes single-layer PZT.

31. The head gimbal assembly according to claim 27, wherein each PZT element includes multi-layer PZT.

32. The head gimbal assembly according to claim 27, wherein each of the PZT portions includes a substrate base and a PZT structure.

33. The head gimbal assembly according to claim 32, wherein the PZT structure is a multi-layer PZT including multiple electrodes and PZT crystal sandwiched between the electrodes.

34. The head gimbal assembly according to claim 27, wherein each of the PZT portions includes a substrate base and a multi-layer PZT structure.

35. The head gimbal assembly according to claim 34, wherein each layer of the PZT structure includes two electrodes that sandwich a thin-film PZT layer.

36. The head gimbal assembly according to claim 27, wherein the slider includes a read/write element for magnetic recording.

37. The head gimbal assembly according to claim 27, wherein the bottom support is connected to a suspension tongue of the suspension.

38. A disk drive device comprising:
a head gimbal assembly including a micro-actuator, a slider, and a suspension that supports the micro-actuator and slider;
a drive arm connected to the head gimbal assembly;
a disk; and
a spindle motor operable to spin the disk,
wherein the micro-actuator includes:
a metal frame including
a bottom support adapted to be connected to a suspension of the head gimbal assembly,
a top support adapted to support a slider of the head gimbal assembly, and
a pair of side arms that interconnect the bottom support and the top support,
the side arms extending vertically from respective sides of the bottom support and the top support; and
a PZT element mounted to each of the side arms, each PZT element including multiple PZT portions, wherein each PZT element is excitable to cause selective movement of the side arms.
